(19) United States
(12) Patent Application Publication
(10) Pub. No.: US 2025/0119731 A1
(43) Pub. Date: Apr. 10, 2025

(54) METHOD, DEVICE, AND SYSTEM FOR SCG SECURITY IN WIRELESS NETWORKS

(71) Applicant: ZTE Corporation, Shenzhen (CN)

(72) Inventors: Zhen XING, Shenzhen (CN); Shilin YOU, Shenzhen (CN); Yuze LIU, Shenzhen (CN); Peilin LIU, Shenzhen (CN)

(73) Assignee: ZTE Corporation, Shenzhen (CN)

(21) Appl. No.: 18/982,701

(22) Filed: Dec. 16, 2024

Related U.S. Application Data
(63) Continuation of application No. PCT/CN2023/070849, filed on Jan. 6, 2023.

(51) Int. Cl. H04W 12/041; H04W 36/36

(52) U.S. Cl. CPC H04W 12/041; H04W 36/362

(57) ABSTRACT

This disclosure relates generally to a method, device, and system for ensuring security related to SCG and/or SN in a wireless network. One method performed by a wireless device is disclosed. The method may include: selecting a target PScell; the target PScell being associated with a target SN; determining whether the SW counter needs to be updated; in determination that the SW counter needs to be updated: incrementing the SW counter by a predefined value; and updating the security key based on the incremented SW counter and the base key; and transmitting, to a master node or the target SN, a first message requesting switching from a current PScell to the target PScell, the first message comprises at least one of: an indicator indicating that an update of the security key in the target SN is needed; or a value of the incremented SW counter.

### TECHNICAL FIELD

This disclosure is directed generally to wireless communications, and particularly to a method, device, and system for ensuring security related to Secondary Carrier Group (SCG) and/or Secondary Node (SN) in a wireless network.

### BACKGROUND

With the rapid evolution of wireless communication technology, and to satisfy the demand for higher speed, higher throughput and capacity, higher efficiency, and lower latency, dual connectivity is introduced in which two base stations are employed to support a Master Carrier Group (MCG) and an SCG. Switching between SCGs and addition of a new SCG, as well as switching between cells within a same SCG are supported in order to achieve robust secondary connection. It is critical to minimize the execution time and improve performance for these procedures.

### SUMMARY

This disclosure is directed to a method, device, and system for ensuring security related to SCG and/or SN in a wireless network.

In some embodiments, a method performed by a wireless device is disclosed. The method may include: in response to an execution condition being satisfied, selecting a target Primary Secondary cell (PScell) in a Radio Access Network (RAN), the target PScell being associated with a target secondary node (SN), wherein: the target SN is associated with an SW counter (SN switch counter); the SW counter and a base key specific to the target SN are used for deriving a security key; the security key is specific to the target SN and is used for securing data between the wireless device and the target SN; and the SW counter and the base key are synchronized between the wireless device and the target SN; determining whether the SW counter needs to be updated; in determination that the SW counter needs to be updated: incrementing the SW counter by a predefined value, wherein, from a last reset of the SW counter, the incremented SW counter is different from any prior SW counters used by the wireless device to derive the security key; and updating the security key based on the incremented SW counter and the base key;

The above method may further include: transmitting, to a master node or the target SN, a first message requesting switching from a current PScell to the target PScell, wherein: in determination that the SW counter needs to be updated, the first message comprises at least one of: an indicator indicating that an update of the security key in the target SN is needed; or the value of the incremented SW counter.

In some embodiments, there is a wireless device, or a network element comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows an exemplary dual connectivity configuration with a gNB acting as a Master Node (MN) and an eNB acting as a Secondary Node (SN).

FIG. 5 shows an exemplary SN addition/modification procedure initiate by a Master Node (MN).

FIG. 6 shows exemplary SN configurations which are pre-configured in a UE.

FIG. 7 shows an exemplary K_{SN}′ derivation process.

FIG. 8 shows an exemplary scheme for maintaining and synchronizing SW counters (SN Switch counters) between UE and SNs.

FIG. 9 shows an exemplary Conditional PScell Change (CPC) or Conditional PScell Addition (CPA) procedure initiated by a UE that is pre-configured with candidate SCGs (or candidate SNs).

FIG. 10 shows another exemplary CPC/CPA procedure initiated by a UE that is pre-configured with candidate SCGs (or candidate SNs).

### DETAILED DESCRIPTION

### Wireless Communication Network

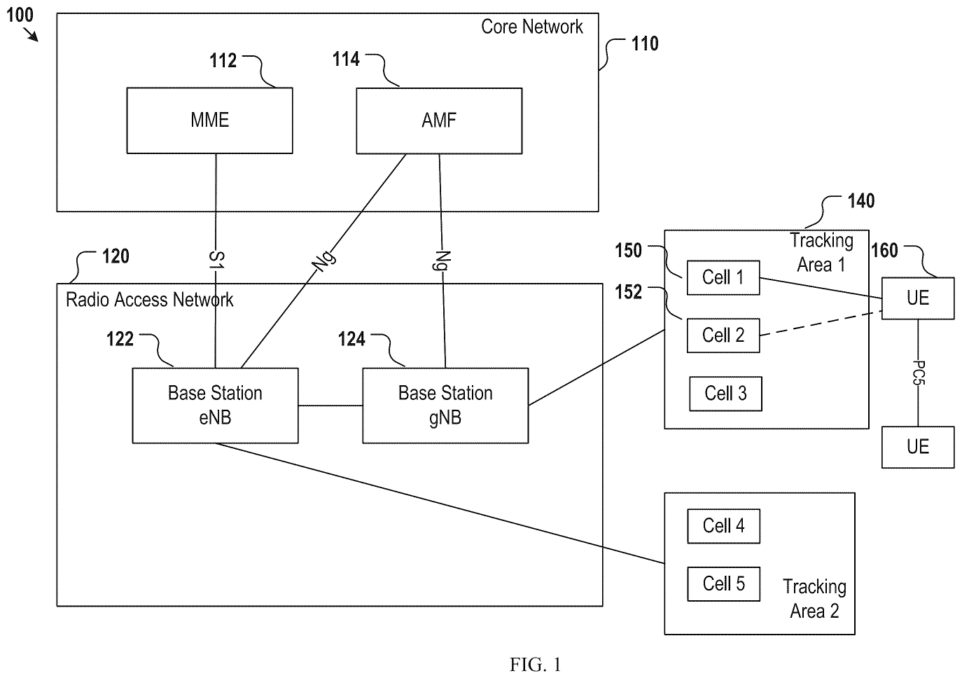

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

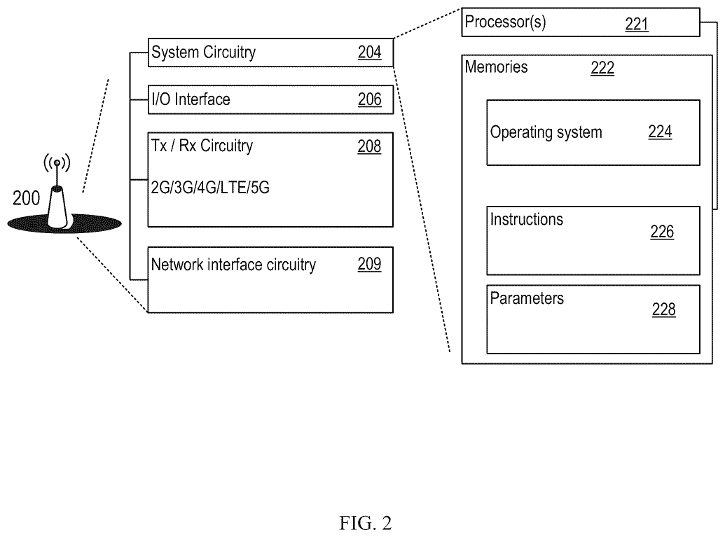

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

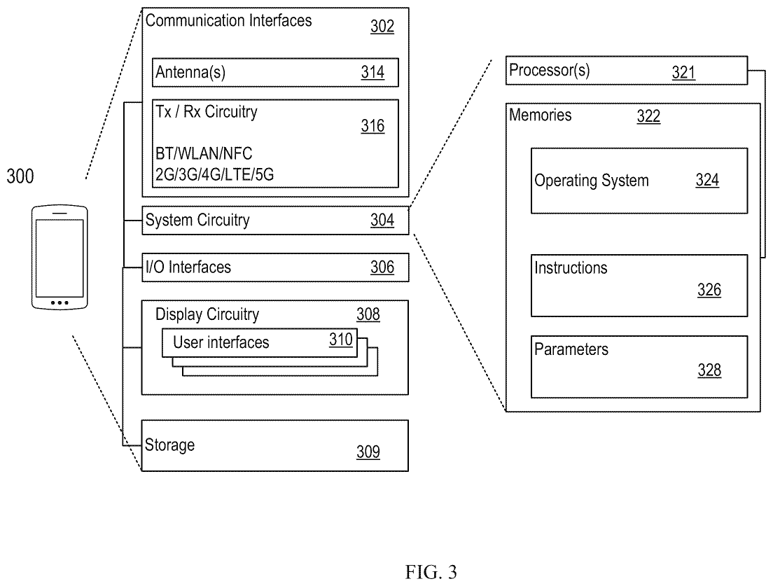

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA) +, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

Network Deployment with Dual Connectivity

With the rapid evolution of wireless communication technology, and to satisfy the demand for higher speed, higher throughput and capacity, higher efficiency, and lower latency, a Dual Connectivity (DC) feature is introduced. In general, in a DC deployment, a UE is allowed to be connected to two base stations (or two nodes) and send/receive data via both base stations. The two base stations may be of same type. For example, both base stations may be eNBs, gNBs, ng-eNBs, and the like. The two base stations may also be of different types. The core network to support the DC deployment may include, for example, an LTE Evolved Packet Core (EPC), or a 5G core.

In a DC deployment, one of the nodes acts as the Master Node (MN) and the other acts as the Secondary Node (SN). In some example implementations, MN is the node to which the UE first connects. Subsequently, UE may connect to the SN.

In some example implementations, only MN is used to provide the control plane connection between the UE and the Core Network. Whereas SN provides additional resources to carry user plane traffic.

In some example implementations, SN may also carry signaling messages.

Example DC configurations include EN-DC (E-UTRA-NR Dual Connectivity), NE-DC (NR-E-UTRA Dual Connectivity), NR-DC (New Radio Dual Connectivity), NGEN-DC (NG-RAN-E-UTRA Dual Connectivity), etc. Exemplarily, an MN may be an eNB (in EN-DC), an ng-eNB (in NGEN-DC), or a gNB (in NR-DC and NE-DC). An SN may be an en-gNB (in EN-DC), an ng-eNB (in NE-DC), or a gNB (in NR-DC and NGEN-DC).

Under certain deployments, DC may be configured in combination with Carrier Aggregation (CA), in which both MN and SN may be associated with multiple cells or carriers. These aggregated carriers are collectively called Master Cell Group (MCG) and Secondary Cell Group (SCG). Note that the MCG is associated with the MN, and the SCG is associated with the SN. Further note that an MCG may implicit imply the MN it associates with, and a SCG may implicit imply the SN it associates with.

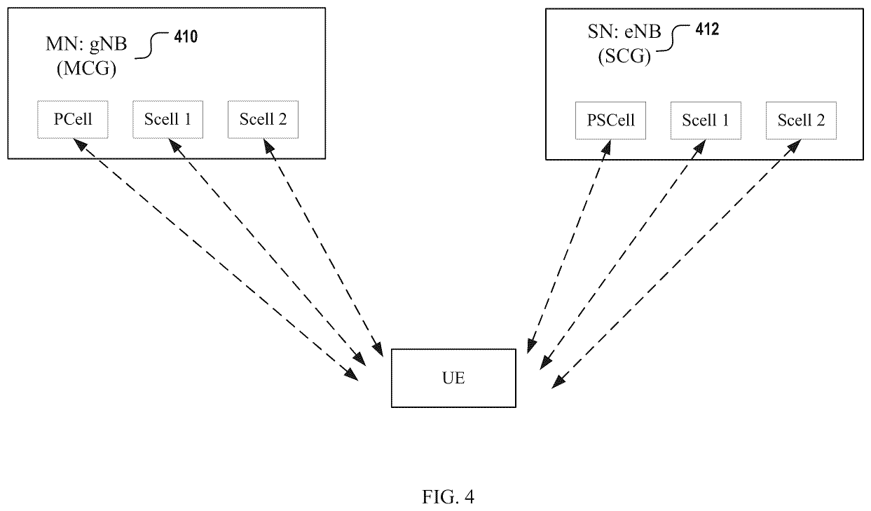

Referring to FIG. 4 for an example DC configuration. In this example, the MCG 410 is associated with MN, which is a gNB, and the SCG 412 is associated with SN, which is an eNB.

The MCG may include a group of serving cells associated with the MN, including a Primary cell (PCell) and optionally one or more Secondary cells (Scells). The SCG may include a group of serving cells associated with the SN, including a Primary SCG Cell (PScell) and optionally one or more Scells. In FIG. 4, MCG 410 is configured with one PCell, and two SCells: Scell 1 and Scell 2. SCG 412 is configured with one PSCell, and two SCells: Scell 1 and Scell 2.

In some implementations, a UE may be configured with multiple candidate SCGs (or SNS). The UE may connect to one MN, but may switch from one SCG to another SCG; or the UE may switch PScell within a same SCG.

In embodiments and example implementation below, a UE may be configured with the DC configuration.

### SN Addition/Modification Procedure (MN Initiated)

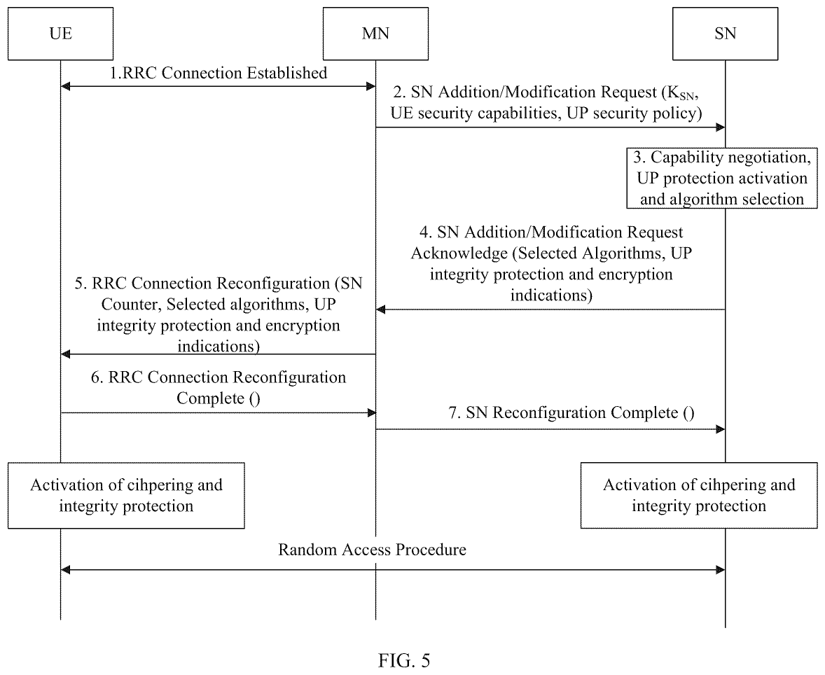

In some example implementations, an SN may be added or changed (modified) by an MN. For example, the UE may switch from one SCG to another SCG (i.e., switch from on SN to another SN) and a PScell change will occur. FIG. 5 illustrates an exemplary overall message/signaling flow for SN addition/modification.

### Step 1

UE establishes a Radio Resource Control (RRC) connection with MN.

### Step 2

MN sends an SN Addition/Modification Request to the SN over the Xn-C interface to negotiate available resources, configuration, and algorithms (e.g., security algorithm) at the SN. If a new security key for the SN (K_{SN}) is needed, the MN may compute and deliver it to the SN. The UE security capabilities and the User Plane (UP) security policy may also be sent to SN.

The UE security capabilities may include capabilities for Next Generation Radio Access Network (NG-RAN), 5G Non-Access Stratum (NAS), 5G Access Stratum (AS), and may further include capabilities for Evolved Packet System (EPS), Universal Terrestrial Radio Access Network (UTRAN), and GSM EDGE Radio Access Network (GERAN), if these access types are supported by the UE. The UP security policy may be used to activate UP confidentiality and/or UP integrity for one or more DRBs belonging to a PDU session associated with the UE.

In case of PDU split, UP integrity protection and ciphering activation decision from MN may be also included in the request.

### Step 3

The SN allocates the necessary resources, such as radio resources, transport network resources. SN may also choose the ciphering algorithm and integrity algorithm which has the highest priority from its configured list and is also present in the UE security capability. If a new K_{SN} was delivered to the SN in step 2, then the SN may compute an RRC key as well as UP keys. The SN may then activate the UP security policy based on the UP keys.

### Step 4

The SN sends SN Addition/Modification Acknowledge to the MN indicating availability of requested resources and the identifiers for the selected algorithm(s) for the requested Data Radio Bearers (DRBs) and/or Signaling Radio Bearers (SRBs) for the UE. The UP integrity protection and encryption indications may also be sent to the MN.

### Step 5

The MN sends the RRC Connection Reconfiguration Request to the UE instructing it to configure the new DRBs and/or SRBs for the SN. The MN may include the SN Counter parameter to indicate that a new K_{SN} is needed and the UE needs to compute the K_{SN} for the SN. The MN forwards the UE configuration parameters (which contains the algorithm identifier(s) received from the SN in step 4), as well as UP integrity protection and encryption indications (received from the SN in step 4) to the UE.

Note that this message may be sent over the RRC connection between the MN and the UE, and it is integrity protected using the K_{RRCint} (an RRC security key) of the MN. Therefore, the SN Counter is tamper-proof.

### Step 6

The UE accepts the RRC Connection Reconfiguration Request after validating its integrity. The UE computes the K_{SN} for the SN if an SN Counter parameter was included. The UE may also compute the needed RRC key and UP key, and activate the RRC and UP protection as per the indications received for the associated SRBs and/or DRBs. The UE sends an RRC Reconfiguration Complete message to the MN. The UE may choose to activate the selected encryption/decryption and integrity protection keys with the SN at this point.

### Step 7

The MN sends an SN Reconfiguration Complete message to the SN, for example, via the Xn-C interface, to inform the SN of the configuration result. On receipt of this message, SN may choose to activate the selected encryption/decryption and integrity protection with UE. Or, if SN does not activate encryption/decryption and integrity protection with the UE at this stage, SN may activate encryption/decryption and integrity protection upon receiving a random access request from the UE.

In this SN addition/modification procedure, the K_{SN} is used for securing connection between the UE and the SN. The UE may calculate the K_{SN} by its own, whereas the SN relies on the MN for the delivery of the K_{SN}.

In some example implementations, the K_{SN} may be derived by a Key Derivation Function (KDF). The KDF may be based on Hash-based Message Authentication Code Secure Hash Algorithm 256 (HMAC-SHA-256). Equation 1 below shows an example for deriving K_{SN} using the KDF:

$${K}_{SN} = KDF ( key , S ) \qquad ( 1 )$$

In equation 1, the KDF has two input: an input key, and a string S. The string S may be a concatenation of multiple strings (or multiple input parameters), for example, by using equation 2 below:

$$S = FC ‖ P 0 ‖ L 0 ‖ P 1 ‖ L 1 ‖ … ‖ Pn ‖ Ln \qquad ( 2 )$$

In equation 2, FC is the function code. In the concatenation, there are multiple parameters (from P0 to Pn, n being a non-negative integer), as well as a length value (i.e., L0, L1, . . . . Ln) for each parameter.

As an example, for deriving K_{SN}, following input may be used:
FC=0x79.
P0=value of the SN Counter as a non-negative integer.
L0=length of P0 (i.e., length of the SN counter value, for example, in bits or bytes).

The input key may be the key for the MN, which may include the K_{eNB} when the MN is an ng-eNB, and K_{gNB} when the MN is a gNB.

### Selective SCG Addition/Change Utilizing Pre-configuration

In the SN addition/modification procedure described in the previous section, a decision for SN addition/modification is made by the MN. Once the MN triggers the procedure, preparation effort, including resource allocation, capability negotiation, algorithm selection, need to be taken by the SN and the UE. A service delay may be introduced by the preparation effort. Therefore, to expedite the procedure and reduce the duration of service interruption, it is desirable to reduce or even get rid of the preparation effort, such that once after the SN addition/modification decision is made, the link between the UE and the SN may be established with minimized effort.

One solution is to move the preparation effort or the preparation phase to an earlier stage, before the SN addition/modification decision is made.

A UE may be preconfigured with a candidate SN pool which includes multiple candidate SNs. For each candidate SN, the UE may be configured with configurations related to, for example, resource allocation, capability negotiation, algorithm selection, etc. The UE may also be configured with execution conditions used for evaluating and triggering SN addition or modification. For a same candidate SN, there may be different execution conditions serving different purposes, such as execution condition for SN addition, and execution condition for SN modification. Further, in some example implementations, a candidate SN may support multiple configurations, for example, configurations serving different Quality of Service (QOS), different security levels, or different throughput. Correspondingly, the UE may evaluate multiple execution conditions for a candidate SN, and may choose an SN configuration that matches a satisfied execution condition.

The SN configurations may be used for Conditional PScell Addition (CPA), and/or Conditional PScell Change (CPC), in the sense that the PScell Addition and PScell Change are triggered when the condition defined by the execution condition is met.

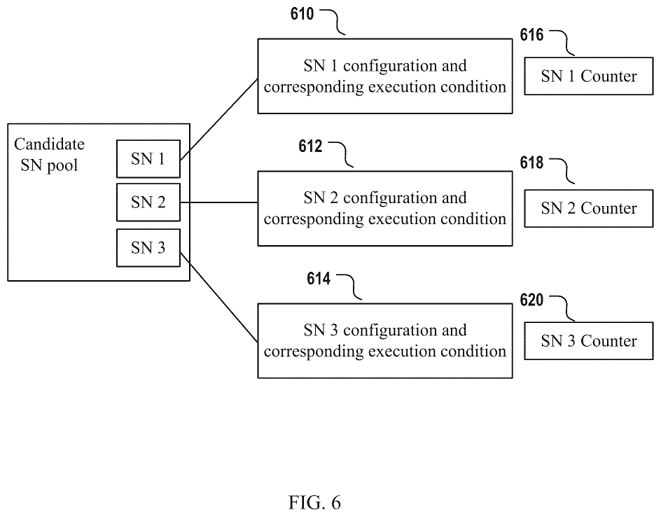

Referring to FIG. 6 for an example. A UE is configured with a candidate SN pool including 3 candidate SNs (SN 1 to SN 3). The SN configurations and execution conditions 610, 612, and 614 are pre-configured to the UE. Based on these pre-configured configurations, the UE may add one of these SNs to add an SCG, or change its SCG from one SN to another SN. The UE may also change its PScell within a same SCG.

Similarly, for each candidate SN, pre-configuration may also be performed to support the CPA/CPC procedure. For example, the candidate SN may be configured with UE capability and UE security preference, to minimize negotiation effort once after the candidate SN is selected for SN addition or modification.

### SN Key (K_{SN}) Transformation

In some embodiments, the link between the UE and an SN (or PScell in the SN) is secured by a key transformed from K_{SN} (security key for the SN, which may be derived using equations 1 and 2), denoted as K_{SN}′. For example, as shown in FIG. 4, the link between the UE and the PScell in SCG 412 may be secured by K_{SN}′. K_{SN}′ is synchronized between the UE and the SN.

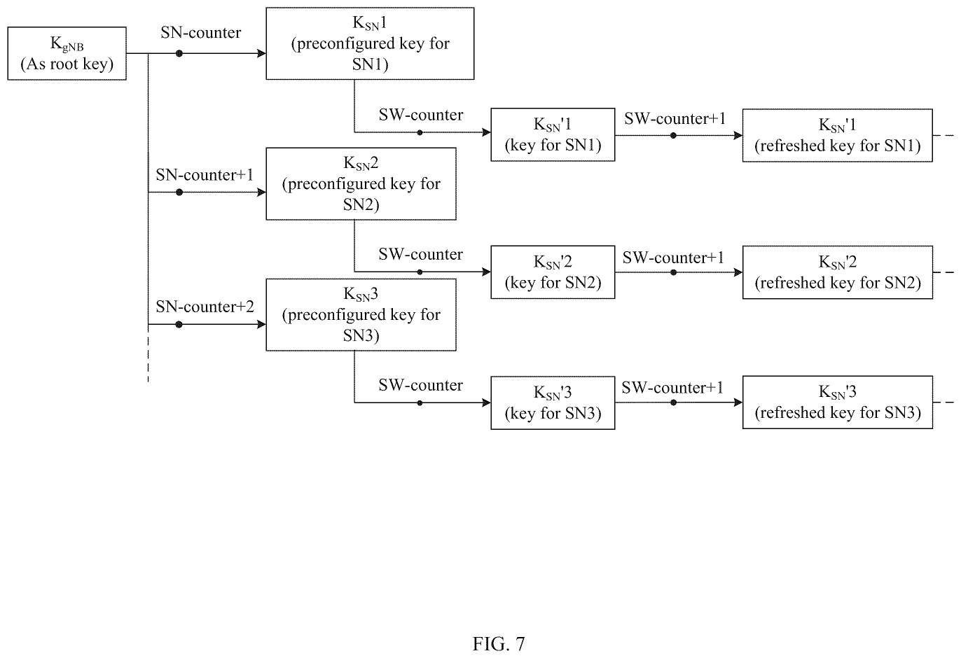

FIG. 7 shows an exemplary K_{SN}′ derivation procedure for each candidate SN in the candidate SN pool. In this example, there are 3 SNs (SN 1 to SN 3). From the UE side, the UE may be pre-configured with an SN counter by, for example, the MN, as a non-negative integer (e.g., 0). First, the UE may compute the security key, K_{SN}, for each SN, as shown in Table 1.

TABLE 1
K_{SN} Derivation

| Security Key for SN | Formula for Deriving Security Key |
|---|---|
| K_{SN}1 (for SN 1) | K_{SN}1 = KDF (root key, string 1), |
| | string 1 is based on SN counter |
| K_{SN}2 (for SN 2) | K_{SN}2 = KDF (root key, string 2), |
| | string 2 is based on SN counter + 1 |
| K_{SN}3 (for SN 3) | K_{SN}3 = KDF (root key, string 3), |
| | string 3 is based on SN counter + 2 |

The root key may be the security key for the MN (master node as shown in FIG. 4), which may include the K_{eNB} when the MN is an ng-eNB, and K_{gNB} when the MN is a gNB. Note that for all candidate SNs in a candidate SN pool, the root key may be the same (as all these candidate SNs are all associated with the same MN).

Using the formulas in Table 1, the KDFs may use the same root key as the input key, but different input strings for each SN. Therefore, the security key K_{SN} is different for each SN.

The K_{SN} for each SN will then serve as a base key for deriving the K_{SN}′ corresponding to the SN. Another counter, SN Switch counter (denoted as SW counter in FIG. 7), is further introduced and preconfigured in the UE side. The SW counter may be pre-configured by, for example, the MN, to an initial integer value, such as 0. The UE may then derive K_{SN}′ using a KDF. As some examples, K_{SN}′1=KDF (K_{SN}1, “string based on SW counter”); or K_{SN}′2=KDF (K_{SN}2, “string based on SW counter”). Note that for a same base key K_{SN}, the K_{SN}′ may be refreshed by refreshing the SW counter (e.g., by increasing SW counter by a predefined integer, such as 1). In embodiments below, great details will be described on how to determine when the SW counter needs to be refreshed.

The base key, K_{SN}, is synchronized between the UE and the corresponding SN. For example, SN 1 maintains a same copy of K_{SN}1 as the UE does. The synchronization may be coordinated by, for example, the MN, via signaling. In some example implementations, the MN may send the K_{SN} to the corresponding SN, whereas the UE may computer the K_{SN} itself.

The SW counter is synchronized between the UE and SN in various forms.

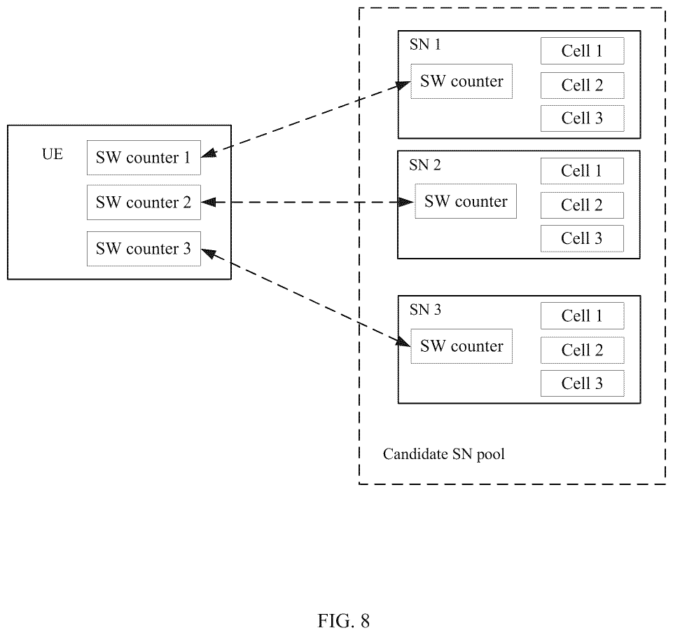

In some example implementations, SW counter be synchronized between the UE and each candidate SN. The UE may maintain one SW counter for each candidate SN, whereas each candidate SN maintains its own SW counter. For example, as shown in FIG. 8, the UE may maintain 3 SW counters: SW counter 1, SW counter 2, and SW counter 3, serving SN 1, SN 2, and SN 3, respectively. Each SN may maintain its own SW counter corresponding to the SW counter in UE side, to form an SW counter pair. SW counters in each pair may be initialized to a same initial value (e.g., 0). When a candidate SN is selected as the target SN, if the SW counter needs to be refreshed, the UE may notify the target SN of the refreshed SW counter value, or an indicator indicating that the SW counter need to be refreshed, so as to keep the SW counters synchronized.

In some other example implementations, SW counter only needs to be synchronized between the UE and a target SN. The target SN is the candidate SN associated with a selected PScell under the CPC/CPA procedure. For example, the target SN may be the candidate SN that the UE will change PScell to (i.e., switching the link to a new PScell under that target SN). The UE may notify the target SN of the refreshed SW counter value.

As the UE and the target SN have synchronized base key (K_{SN}) and SW counter, the K_{SN}′ may then be able to computed on each side and synchronized between the UE and the target SN.

The K_{SN}′ may be derived in various manners by using KDF with different input strings, which are described below.

Exemplarily, K_{SN}′=KDF (K_{SN}, input string). Refer to equation 2 for details on how the input string is formed by input parameters.

In some example implementations, the following input parameters may be used:
FC=0x7E.
P0=Value of the SW Counter as a non-negative integer.
L0=length of the SW Counter value (e.g., 1 byte, 2 bytes, etc).

In some example implementations, the following input parameters may be used:
FC=0x7E.
P0=Value of the SP-Counter as a non-negative integer.
L0=length of the SP-Counter value.
P1=PSCell id or ARFCN-DL of the target PScell (Absolute Radio-Frequency Channel Number in downlink direction, for example, the absolute frequency of SSB (Synchronization Signal/PBCH Block) of the target PScell).
L1=length of PSCell id or ARFCN-DL.

In some example implementations, the following input parameters may be used:
FC=0x7E.
P0=Value of the SP-Counter as a non-negative integer.
L0=length of the SP-Counter value (i.e. 0x00 0x02).
P1=PSCell id of the target PScell.
L1=length of the PSCell id.
P2=ARFCN-DL of the target PScell.
L2=length of ARFCN-DL (i.e. 0x00 0x03).

### Embodiment 1: Selective SCG Addition/Change with Security Key Refresh

In this embodiment, the UE is preconfigured with candidate SN/SCG configurations to expedite CPC/CPA procedure. For each candidate SN in the candidate SN pool, the K_{SN} is synchronized between the UE and each candidate SN. Note that the K_{SN} may be derived based on equation 1 as described earlier. A transformation of K_{SN}, denoted as K_{SN}′, as described in previous sections, is maintained by both the UE and each candidate SN, and is used for securing the link between the UE and a corresponding candidate SN.

Under a CPA/CPC procedure, a UE may stick to a Pcell in an MCG, and either add a new PScell, or switch to a another PScell in a different or a same SCG (or SN). The UE may keep the preconfigured SN/SCG configurations, and may switch back and forth to a same PScell multiple times. Depending on the different PScell addition/switching scenarios, the K_{SN}′ for the SN that is used for securing the link between the UE and the SN may be re-used, or may need to be refreshed to enforce security. In this embodiment, a K_{SN}′ refresh mechanism is described in great details.

When UE is configured with multiple candidate SNs, for securing the link between the UE and a candidate SN, a security key for the candidate SN, namely K_{SN}′, as described in previous sections, is used. The K_{SN}′ may be derived as described in earlier section, for example, K_{SN}′=KDF (K_{SN}, “string based on SW counter”). In particular, the input key may be the security key for the SN, which is also referred to as a “based key” for computing K_{SN}′.

There are several security requirements for K_{SN}′. First, each candidate SN has its own unique K_{SN}′. Second, for a same candidate SN, there is a refresh requirement, such that under certain condition, the K_{SN}′ will need to be refreshed, or updated. More details will be described in later paragraphs.

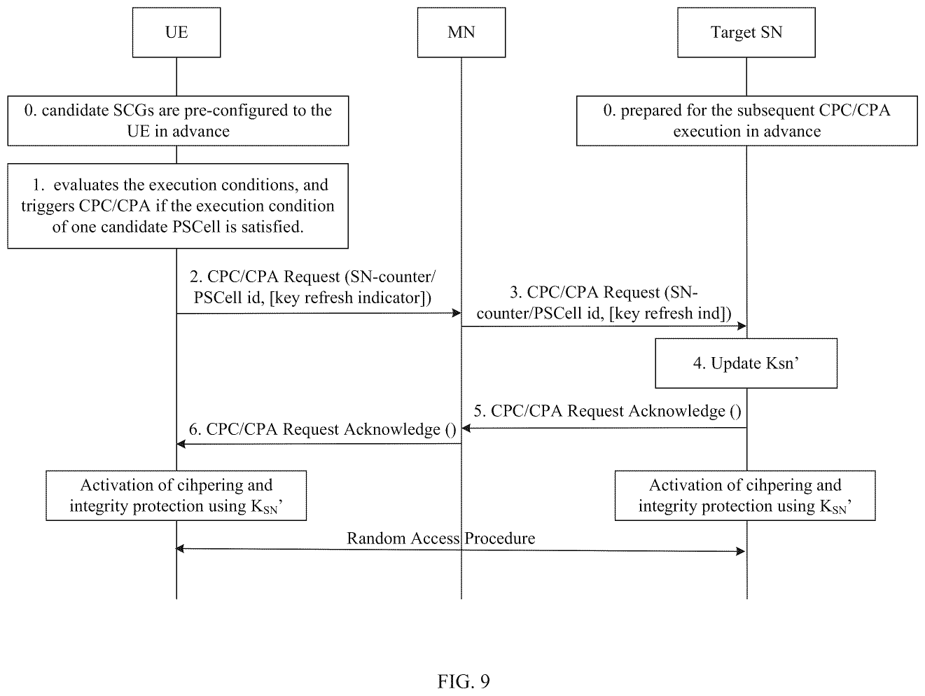

FIG. 9 shows an example message flow for a UE initiated CPC/CPA procedure, which includes following steps.

### Step 0

This step may serve as a pre-configuration phase.

A UE may be preconfigured with a candidate SN pool (or SCG pool) which includes multiple candidate SNs (or multiple candidate SCGs). Referring back to FIG. 6, For each candidate SN, the UE maintains configurations including: Conditional PScell Addition (CPA) configuration; and/or Conditional PScell Change (CPC) configuration. The UE may also be pre-configured with execution conditions corresponding to the CPA and CPC configurations. For example, when a CPA execution condition is met, a subsequent PScell Addition may be performed according to the CPA configuration.

In some example implementations, for each candidate SN (or candidate SCG), the UE may be pre-configured with a SN counter. The MN may assign a unique initial value to each of the SN counters. For example, the initial values for the 3 SN counters as shown in FIG. 6 may be: 0, 1, and 2, respectively.

Alternatively, in some other example implementations, UE only needs to maintain one SN counter as a base counter, and will derive a respective SN counter value to be applied to each SN. For example, the base value preconfigure to the SN counter may be 0, and the UE may start with the base value, and derive/assign a counter value for each SN, for example, by incrementing the SN counter value after each assignment. Exemplarily, UE may receive the base counter from the MN.

As described earlier, the UE also maintains one or more SW counters, depending on the specific implementation. The underlying principle or requirement is that the SW counter is synchronized between the UE and the target SN (for hosting a selected PScell in the event of CPC/CPA). Details on how to maintain and synchronize the SW counter may be referred back to the “SN Key (K_{SN}) Transformation” section.

In the SN side, each candidate SN can be prepared for the subsequent CPC/CPA execution in advance. Each SN may be preconfigured with a SN counter, and a SW counter, which are synchronized with the UE. For example, the initial value of the SP counter may be set to “0”. Each SN may also acquire its K_{SN} from the MN, and may then compute its K_{SN}′ either in this step, or in a later step before the first CPC/CPA procedure.

### Step 1

The UE evaluates the execution conditions. If the CPA/CPC execution condition is met for a particular PScell under a candidate SN, the UE will select the PScell (and its associated candidate SN, also referred to as the target SN) and proceed with the CPA/CPC procedure. The execution condition for CPA and CPC may be different.

As an example, referring to FIG. 8, the UE is pre-configured with 3 SNs: SN 1, SN 2, and SN 3. Each SN has 3 cells: cell 1, cell 2, and cell 3. The UE has a current dual connectivity and the current PScell is cell 1 under SN 1. The UE may select cell 2 under SN 2 to execute CPC procedure, if the CPC execution condition is met. In this case, SN 2 is the target SN.

### Step 2

The UE triggers the CPC/CPA procedure towards the selected PSCell, by sending a CPC/CPA Request message to MN. The message may include at least one of: the SN counter for the target SN (i.e., candidate SN associated with the selected PSCell); or an identifier, such as an the PSCell id of the selected PSCell, for identifying the target SN associated with the selected PScell.

The SW counter for the target SN associated with the selected PSCell may or may not need to be refreshed (updated) from a current value. In the event that the selected PSCell is associated with a SN that is different from the SN associated with the current PScell in a dual connectivity, the SW counter needs to be refreshed. Correspondingly, the K_{SN}′ for the candidate SN may also need to be updated, and the UE will need to re-compute the K_{SN}′ based on the refreshed SW counter. In determination that the SW counter needs to be refreshed, the CPC/CPA Request message may further include either an SW counter refresh indicator indicating that the SW counter needs to be refreshed, or the refreshed SW counter value.

As an example, turning back to FIG. 8, assuming the current dual connectivity uses cell 1 in SN 1 as PScell (i.e., SN 1 is the current SN). The UE determines that the PScell needs to be changed to cell 2 under SN 2. In this case, as the selected PScell is associated with a SN different from the current SN, the SW counter for SN 2 (which is the SN associated with the selected PScell) needs to be refreshed, and the K_{SN}′ for SN 2 needs to be updated.

As another example, in FIG. 8, assuming the current dual connectivity uses cell 1 in SN 1 as PScell (i.e., SN 1 is the current SN). The UE determines that the PScell needs to be changed to cell 2 under the same SN. In this case, there is no SN change, so the SW counter for SN 1 does not need to be refreshed, and the K_{SN}′ for SN 1 may be re-used without update.

In some example implementations, the UE maintains an SW counter for each SN. When refreshing the SW counter of the selected candidate SN, the UE may increase the SW counter value by an offset (e.g., predefined positive integer, such as 1), to obtain a refreshed value for the SW counter of the selected candidate SN (i.e., target SN), note that it is required that the refreshed value has not been used for computing the K_{SN}′ for a same candidate SN. The offset may be configured by the MN.

As an example, assuming that before the SW counter refresh, the UE maintains 3 SW counters (one for each SN) with following values:
SW counter 1:0; SW counter 2:1; SW counter 3:2 .

Assuming UE needs to refresh the SW counter 2 (for SN 2) based on the determination logic described above, the UE may increase SW counter 2 by 1. After the refresh, the 3 SW counters have following values (with SW counter 2 value updated):
SW counter 1:0; SW counter 2:2; SW counter 3:2.

As an SW counter has an upper limit, in the event that the SW counter reaches its upper limit, a reset on the counter would occur (this may be referred to as a SW counter wraparound). Each reset marks a new cycle of the SW counter. In such a reset event, all SN counters may be update by, for example, the MN, to different values. This type of SN counter update may be considered as SN counter re-initialization with different initial value. For example, initial SN counter values {0, 1, 2} may apply to 3 candidate SNs. After a re-initialization, SN counter values may be reset to {3, 4, 5}. A corresponding K_{SN} needs to be computed based on the re-initialized SN counter, to obtain updated K_{SN}, serving as base key for deriving K_{SN}′. Therefore, when considering the SW counter wraparound/reset, the requirement will be that within each cycle of the SW counter, the refreshed SW counter value should not have been used for computing the K_{SN}′ for a same candidate SN.

### Step 3

The MN sends an CPC/CPA Request message (for SN Addition/Modification) to the SN (i.e., the target SN), for example, via the Xn-C interface. Exemplarily, the MN may transparently forward the SN Addition/Modification Request to the SN.

### Step 4

The SN, upon receiving the CPC/CPA Request message, determines that the SW counter needs to be refreshed, if the SW counter refresh indicator or a refreshed SW counter value is carried in the CPC/CPA Request message. the SN proceeds to update its K_{SN}′ by using the same key derivation method as the UE does. That is, the K_{SN}′ is derived base on the base key (K_{SN}) of the SN, and a string based on the SW counter value. Note that the base key and the SW counter are synchronized between the SN and the UE.

### Step 5

The SN sends an CPC/CPA Request Acknowledge message to the MN, for example, via the Xn-C interface. SN may activate the chosen encryption/decryption and integrity protection with UE, based on pre-configured configurations. If SN does not activate encryption/decryption and integrity protection with the UE at this stage, SN may choose to activate encryption/decryption and integrity protection upon receiving the Random Access request from the UE. Note that if in step 2, an updated K_{SN}′ for the SN is needed, then the encryption/decryption and integrity protection are based on the updated K_{SN}′, otherwise the current K_{SN}′ may be used for the security protection.

### Step 6

The MN sends the CPC/CPA Request Acknowledge message to UE. On receipt of this message, the UE may activate the chosen encryption/decryption and integrity protection keys with the SN at this point, based on K_{SN}′.

In this embodiment, a UE maintains an SW counter for each candidate SN in a candidate SN pool (e.g., FIG. 8, SW counter 1 to SW counter 3). When the UE switches to a PScell under a target SN that is different from a current SN associated with the current PScell, the SW counter for the target SN is refreshed, and a new K_{SN}′ will be computed by both the UE and the target SN. The updated K_{SN}′ will be used for securing the link between the UE and the target SN (e.g., link between the UE and the target PScell of the target SN).

Alternatively, a single SW counter implementation may be used, as described earlier.

### Embodiment 2: Selective SCG Addition/Change with Security Key Refresh

This embodiment is similar to embodiment 1. For example, the underlying principle and mechanism for synchronizing SW counter and K_{SN}′ still apply. One difference has to do with the MN involvement in the overall CPC/CPA procedure. Specifically, in the preparation stage (as seen in step 0 of embodiment 1), various resources, such as radio resources and transport network resources may be prepared in the candidate SNs and the UE. Therefore, the UE and a candidate SN may communicate with each other directly, without MN involvement.

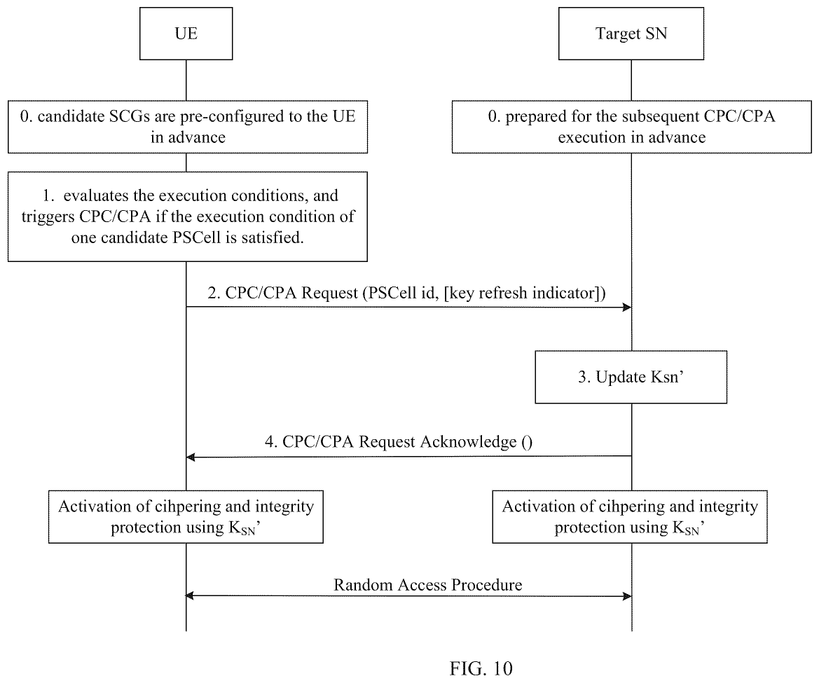

FIG. 10 shows an example message flow for a UE initiated CPC/CPA procedure, in which the UE and a candidate SN (target SN) communicate/negotiate directly after the preparation stage. The procedure includes following steps.

### Step 0

This is the preparation step for pre-configurations. See step 0 of embodiment 1 for details.

### Step 1

UE evaluates execution conditions for triggering CPC/CPA. See step 1 of embodiment 1 for details.

### Step 2

This step is similar to step 2 of embodiment 1, except that the UE sends the CPC/CPA Request message directly to the target SN, without MN involvement.

### Step 3

The SN, upon receiving the CPC/CPA Request message, determines that the SW counter needs to be refreshed, if the SW counter refresh indicator or a refreshed SW counter value is carried in the CPC/CPA Request message. the SN proceeds to update its K_{SN}′ by using the same key derivation method as the UE does. That is, the K_{SN}′ is derived base on the base key (K_{SN}) of the SN, and a string based on the SW counter value. Note that the base key and the SW counter are synchronized between the SN and the UE.

### Step 4

Step 4 is similar to step 5 of embodiment 1, except that the SN sends the CPC/CPA Request Acknowledge message directly to the UE, without MN involvement.

On receipt of this CPC/CPA Request Acknowledge message, the UE may activate the chosen encryption/decryption and integrity protection keys with the SN at this point, based on K_{SN}′.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a wireless device in a wireless network, comprising:
in response to an execution condition being satisfied, selecting a target Primary Secondary cell (PScell) in a Radio Access Network (RAN), the target PScell being associated with a target secondary node (SN), wherein:
the target SN is associated with an SW counter (SN switch counter);
the SW counter and a base key specific to the target SN are used for deriving a security key;
the security key is specific to the target SN and is used for securing data between the wireless device and the target SN; and
the SW counter and the base key are synchronized between the wireless device and the target SN;
determining whether the SW counter needs to be updated;
in determination that the SW counter needs to be updated:
incrementing the SW counter by a predefined value, wherein, from a last reset of the SW counter, the incremented SW counter is different from any prior SW counters used by the wireless device to derive the security key; and
updating the security key based on the incremented SW counter and the base key; and
transmitting, to a master node or the target SN, a first message requesting switching from a current PScell to the target PScell, wherein:
in determination that the SW counter needs to be updated, the first message comprises at least one of:
an indicator indicating that an update of the security key in the target SN is needed; or
a value of the incremented SW counter.

2. The method of claim 1, wherein determining whether the SW counter associated with the target SN needs to be updated comprises:
in response to the SN associated with the target PScell being different from an SN associated with the current PScell, determining that the SW counter associated with the target SN needs to be updated.

3. The method of claim 1, wherein the wireless device has dual connections with the RAN, the dual connections comprising a primary connection between the wireless device and the master node, and secondary connection between the wireless device and the current PScell.

4. The method of claim 1, wherein an initial value of the SW counter is preconfigured by the master node to an integer value.

5. The method of claim 1, wherein the base key is derived by using a key derivation function based on at least one of following inputs:
a root key of the master node; or
an SN counter which is based on an initial SN counter value configured by the master node.

6. The method of claim 1, wherein a reset of the SW counter is triggered by a wraparound of the SW counter, the method further comprising resetting the base key.

7. The method of claim 1, wherein before selecting the target PScell in response to the execution condition being satisfied, the method further comprises: receiving, from the master node, an initial value for the SW counter.

8. The method of claim 1, wherein updating the security key based on the incremented SW counter and the base key comprises:
deriving the security key using a key derivation function, an input to the key derivation function comprising at least one of:
an input key based on the base key; or
input parameters comprising at least the incremented SW counter.

9. The method of claim 8, wherein the input parameters further comprise at least one of:
an identifier of the target PScell; or
an Absolute Radio-Frequency Channel Number in downlink direction (ARFCN-DL) of the target PScell.

10. The method of claim 9, wherein the input parameters further comprise at least one of:
a first length of the identifier of the target PScell; or
a second length of ARFCN-DL of the target PScell.

11. The method of claim 1, further comprising:
receiving, from the master node or the target SN, a second message indicating that the target SN is ready to establish secured connection with the wireless device based on the updated security key.

12. The method of claim 11, further comprising:
activating security configuration associated with the target PScell, based on the updated security key.

13. The method claim 1, wherein:
the wireless device is configured with a list of candidate SNs;
the target SN belongs to the list of candidate SNs; and
each candidate SN in the list of candidate SNs is associated with a corresponding SW counter.

14. The method of claim 13, further comprising:
receiving, from the master node, an initial value for each of the SW counter corresponding to the each candidate SN in the list of candidate SNs.

15. The method claim 1, wherein each of the master node and the target SN comprises a base station, the base station comprising one of:
a gNodeB (gNB);
an eNodeB (eNB);
an ng-eNodeB (ng-eNB); or
a NodeB.

16-17. (canceled)

18. A wireless device comprising a memory for storing computer instructions and a processor in communication with the memory, wherein, when the processor executes the computer instructions, the processor is configured to cause the wireless device to:
in response to an execution condition being satisfied, select a target Primary Secondary cell (PScell) in a Radio Access Network (RAN), the target PScell being associated with a target secondary node (SN), wherein:
the target SN is associated with an SW counter (SN switch counter);
the SW counter and a base key specific to the target SN are used for deriving a security key;
the security key is specific to the target SN and is used for securing data between the wireless device and the target SN; and
the SW counter and the base key are synchronized between the wireless device and the target SN;
determine whether the SW counter needs to be updated;
in determination that the SW counter needs to be updated:
increment the SW counter by a predefined value, wherein, from a last reset of the SW counter, the incremented SW counter is different from any prior SW counters used by the wireless device to derive the security key; and
update the security key based on the incremented SW counter and the base key; and
transmit, to a master node or the target SN, a first message requesting switching from a current PScell to the target PScell, wherein:
in determination that the SW counter needs to be updated, the first message comprises at least one of:
an indicator indicating that an update of the security key in the target SN is needed; or
a value of the incremented SW counter.

19. The wireless device of claim 18, wherein, when the processor is configured to cause the device to determine whether the SW counter associated with the target SN needs to be updated comprises:
in response to the SN associated with the target PScell being different from an SN associated with the current PScell, determine that the SW counter associated with the target SN needs to be updated.

20. The wireless device of claim 18, wherein the wireless device has dual connections with the RAN, the dual connections comprising a primary connection between the wireless device and the master node, and secondary connection between the wireless device and the current PScell.

21. The wireless device of claim 18, wherein an initial value of the SW counter is preconfigured by the master node to an integer value, and wherein the base key is derived by using a key derivation function based on at least one of following inputs:
a root key of the master node; or
an SN counter which is based on an initial SN counter value configured by the master node.

22. A non-transitory storage medium for storing computer readable instructions, the computer readable instructions, when executed by a processor in a wireless device, causing the processor to:
in response to an execution condition being satisfied, select a target Primary Secondary cell (PScell) in a Radio Access Network (RAN), the target PScell being associated with a target secondary node (SN), wherein:
the target SN is associated with an SW counter (SN switch counter);
the SW counter and a base key specific to the target SN are used for deriving a security key;
the security key is specific to the target SN and is used for securing data between the wireless device and the target SN; and
the SW counter and the base key are synchronized between the wireless device and the target SN;
determine whether the SW counter needs to be updated;
in determination that the SW counter needs to be updated:
increment the SW counter by a predefined value, wherein, from a last reset of the SW counter, the incremented SW counter is different from any prior SW counters used by the wireless device to derive the security key; and
update the security key based on the incremented SW counter and the base key; and
transmit, to a master node or the target SN, a first message requesting switching from a current PScell to the target PScell, wherein:
in determination that the SW counter needs to be updated, the first message comprises at least one of:
an indicator indicating that an update of the security key in the target SN is needed; or
a value of the incremented SW counter.
